(19) United States
(12) Patent Application Publication
(10) Pub. No.: US 2012/0182261 A1
(43) Pub. Date: Jul. 19, 2012

(54) TOUCH-SENSITIVE DEVICE AND TOUCH-SENSITIVE DISPLAY DEVICE

(76) Inventors: Wen-Chun WANG, Taichung City (TW); Ting-Yu Chang, Kao Hsiung County (TW); Wen-Tui Liao, Tai Chung City (TW); Ching-Fu Hsu, Tai Chung County (TW); Tsung-Yu Wang, Taichung City (TW); Chih-Yuan Wang, Tai Chung City (TW); Yu-Hua Wu, Tao Yuan County (TW); Cheng-Yi Chou, Yun Lin County (TW); Xuan-Chang Shiu, Chang Hua County (TW); Fa-Chen Wu, Yun Lin County (TW)

(21) Appl. No.: 13/354,114

(22) Filed: Jan. 19, 2012

(30) Foreign Application Priority Data
Jan. 19, 2011 (TW) 100101888

(51) Int. Cl. G06F 3/044

(52) U.S. Cl. 345/174; 178/18.06

(57) ABSTRACT

A touch-sensitive device includes a first and a second substrate and a first and a second touch-sensing electrode structure. The first touch-sensing electrode structure is disposed on the first substrate, and at least one touch position of a conductor is detected by sensing the capacitance variation of the first touch-sensing electrode structure. The second touch-sensing electrode structure is disposed on one side of the second substrate back to the first touch-sensing electrode structure. At least one touch position of an insulator is detected by sensing a variation of the interval between the first touch-sensing electrode structure and the second touch-sensing electrode structure.

### BACKGROUND OF THE INVENTION

a. Field of the Invention

The invention relates to a touch-sensitive device and a touch-sensitive display device.

b. Description of the Related Art

FIG. 1 shows a schematic diagram of a touch-sensitive device disclosed in US patent application no. 20100001969, where the touch-sensitive device 100 supports the input of a finger 102 and a stylus 104. In the touch-sensitive device 100, multiple X-axis electrodes 106a and Y-axis electrodes 106b are formed on one side of a glass substrate 108, and a transparent conductive layer 110 is spaced from the X-axis electrodes 106a and the Y-axis electrodes 106b with an interval h. When the finger 102 touches the touch-sensitive device 100, static electricity is conducted to the touch-sensitive device 100 via the finger 102 to change the capacitance of the X-axis electrodes 106a and the Y-axis electrodes 106b. In comparison, when the stylus 104 touches the touch-sensitive device 100, the glass substrate 108 deforms to have a deformation amount Δh and meanwhile a coupling capacitance is formed between the electrodes 106a and 106b and the transparent conductive layer 110 to activate the touch-sensitive device 100. However, since an interval h between the electrodes 106a and 106b and the transparent conductive layer 110 is equal to an interval between the glass substrate 108 and a glass substrate 112, the overall thickness of the touch-sensitive device 100 fails to be further minimized. Besides, as shown in FIG. 2, when the touch-sensitive device 100 is combined with a display panel 150 by an optical adhesive to form a touch-sensitive display device 200, a thin device fails to be achieved since the touch-sensitive device 100 has a bottom glass substrate 114 and the display panel 150 has a top glass substrate 152 to result in a considerable thickness.

### BRIEF SUMMARY OF THE INVENTION

The invention provides a thin touch-sensitive device and touch-sensitive display device having high production yields and supporting the input of a conductor and an insulator.

In order to achieve one or a portion of or all of the objects or other objects, one embodiment of the invention provides a touch-sensitive device including a first substrate, a first touch-sensing electrode structure, a second substrate and a second touch-sensing electrode structure. The first touch-sensing electrode structure is disposed on the first substrate, where at least one touch position of a conductor is detected by sensing the capacitance variation of the first touch-sensing electrode structure. The second substrate is disposed adjacent to the first substrate and spaced from the first substrate with an interval. The second touch-sensing electrode structure is disposed on one side of the second substrate back to the first touch-sensing electrode structure. At least one touch position of an insulator is detected by sensing a variation of the interval between the first touch-sensing electrode structure and the second touch-sensing electrode structure.

In one embodiment, the first substrate has a first side and a second side opposite the first side, the first touch-sensing electrode structure includes a plurality of first sensing series and a second sensing series crossing the first sensing series, and the second touch-sensing electrode structure includes a transparent electrode layer. In one embodiment, the first sensing series are disposed on the first side of the first substrate and the second sensing series are disposed on the second side of the first substrate.

In one embodiment, the touch-sensitive device further includes a third substrate disposed adjacent to the first side of the first substrate. The first sensing series are formed on one side of the third substrate facing the first substrate, and the second sensing series are formed on the second side of the first substrate.

In one embodiment, the first touch-sensing electrode structure comprises a plurality of regularly arranged button electrodes.

In one embodiment, the touch-sensitive device further includes a decorative film disposed adjacent to the first side of the first substrate.

In one embodiment, a decorative layer is formed on a periphery of the first substrate, and the decorative layer includes at least one of diamond like carbon, ceramic, colored ink, resin and photo resist.

In one embodiment, the first touch-sensing electrode structure comprises a plurality of regularly arranged button electrodes.

In one embodiment, the second touch-sensing electrode structure is floating, connected to a voltage source, directly grounded or connected to a capacitor before being grounded.

In one embodiment, the interval is filled with at least one of a gas, a solid-state filler and a liquid-state filler.

According to the above embodiments, since the interval between the substrate and the substrate is substantially equal to the interval between the first touch-sensing electrode structure and the second touch-sensing electrode structure minus the thickness of the substrate, the overall thickness of the touch-sensitive device is allowed to be reduced (minus the thickness of the substrate) to realize a thin touch-sensitive device.

According to another embodiment of the invention, a touch-sensitive display device includes a first substrate, an OLED formed on the first substrate, a cover plate, a first touch-sensing electrode structure, a second substrate and a second touch-sensing electrode structure. The cover plate is connected to the first substrate to seal the OLED between the first substrate and the cover plate, and the second substrate is disposed on one side of the cover plate back to the OLED and spaced from the cover plate with an interval. The first touch-sensing electrode structure is disposed on the second substrate, and at least one touch position of a conductor is detected by sensing the capacitance variation of the first touch-sensing electrode structure. The second touch-sensing electrode structure is formed on one side of the cover plate back to the second substrate, and at least one touch position of an insulator is detected by sensing the variation of the interval between the first touch-sensing electrode structure and the second touch-sensing electrode structure.

In one embodiment, the first touch-sensing electrode structure includes a plurality of first sensing series and a plurality of second sensing series crossing the first sensing series, and the first sensing series and the second sensing series are formed on a single side of the second substrate.

In one embodiment, the touch-sensitive display device further includes a third substrate disposed adjacent to one side of the second substrate back to the cover plate, and the first touch-sensing electrode structure are formed on the second substrate and the third substrate.

In one embodiment, the interval between the second substrate and the cover plate is filled with at least one of a gas, a solid-state filler and a liquid-state filler, and photo spacers or dot spacers are dispersed in the interval.

In one embodiment, a decorative layer is formed on a periphery of the second substrate, and the decorative layer comprises at least one of diamond like carbon, ceramic, colored ink, resin and photo resist.

According to another embodiment of the invention, a touch-sensitive display device includes a cover lens structure having a first touch-sensing electrode structure, a liquid crystal display, a first linear polarizer, a second linear polarizer and a second touch-sensing electrode structure. At least one touch position of a conductor is detected by sensing the capacitance variation of the first touch-sensing electrode structure. The liquid crystal display is disposed on one side of the cover lens structure, and the first linear polarizer disposed between the cover lens structure and the liquid crystal display. The second linear polarizer is disposed on one side of the liquid crystal display back to the cover lens structure, and the second touch-sensing electrode structure is disposed on one side of the first linear polarizer back to the first touch-sensing electrode structure. The second touch-sensing electrode structure is spaced from the first touch-sensing electrode structure with an interval, and at least one touch position of an insulator is detected by sensing the variation of the interval between the first touch-sensing electrode structure and the second touch-sensing electrode structure.

In one embodiment, the cover lens structure has a cover glass and a first touch-sensing electrode structure formed on the cover glass, and the second touch-sensing electrode structure is formed on one side of the first linear polarizer back to the first touch-sensing electrode structure.

In one embodiment, the cover lens structure includes a first substrate, a cover glass covering the first substrate and a first touch-sensing electrode structure, where the first touch-sensing electrode structure is formed on one side of the first substrate back to the cover glass.

In one embodiment, the touch-sensitive display device further includes a circular polarizer disposed on one side of the first touch-sensing electrode structure.

In one embodiment, the touch-sensitive display device further includes a decorative layer formed on a periphery of the cover lens structure, and the decorative layer includes at least one of diamond like carbon, ceramic, colored ink, resin and photo resist.

According to the above embodiments, a piece of glass substrate and an optical adhesive to adhere the glass substrate are allowed to be omitted from each of the touch-sensitive display devices, as compared with conventional designs. Accordingly, the loss of reflection light and the overall thickness of a touch-sensitive display device are reduced. Besides, the complexity is reduced and the production yields are improved in the integration process of a force sensor and an OLED device. Further, since a bottom substrate of a force sensor and a sealing cap of an OLED device in a conventional design are merged together to form the cover plate, an air gap no longer exists therebetween to further improve the light-reflection efficiency.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a conventional touch-sensitive device.

FIG. 2 shows a schematic diagram of a conventional touch-sensitive display device.

FIG. 3 shows a schematic diagram of a touch-sensitive device according to an embodiment of the invention.

FIG. 4 shows a schematic diagram of a touch-sensitive device according to another embodiment of the invention.

FIG. 5 shows a schematic diagram of a touch-sensitive device according to another embodiment of the invention.

FIGS. 6A-6C show schematic diagrams of touch-sensing electrode structures according to different embodiments of the invention.

FIG. 7A shows a schematic diagram of a touch-sensitive device according to another embodiment of the invention, and FIG. 7B shows a touch-sensing electrode structure of the touch-sensitive device shown in FIG. 7A.

FIG. 8 shows a schematic diagram of a touch-sensitive display device according to an embodiment of the invention.

FIG. 9 shows a schematic diagram of a touch-sensitive display device according to another embodiment of the invention.

FIG. 10 shows a schematic diagram of a touch-sensitive display device according to another embodiment of the invention.

FIG. 11 shows a schematic diagram of a touch-sensitive display device according to another embodiment of the invention.

FIG. 12 shows a schematic diagram of a touch-sensitive display device according to another embodiment of the invention.

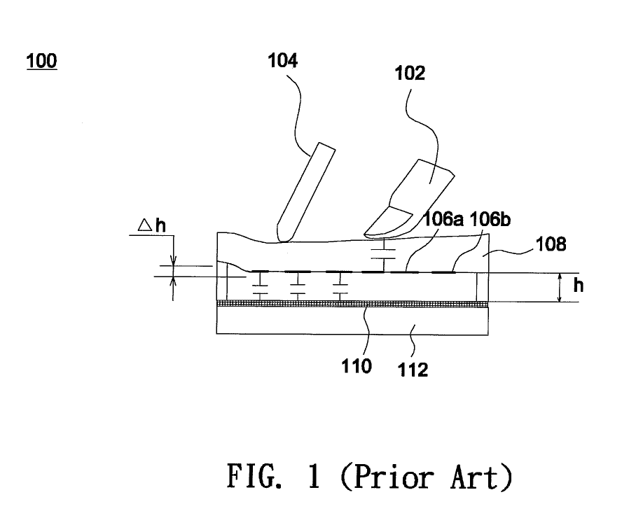

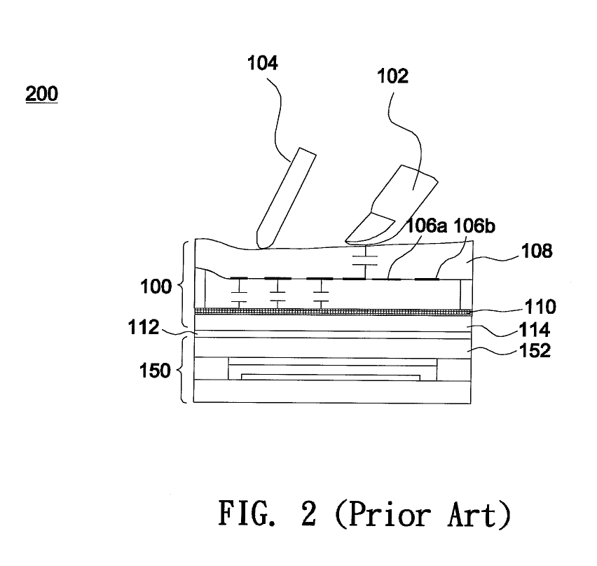

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

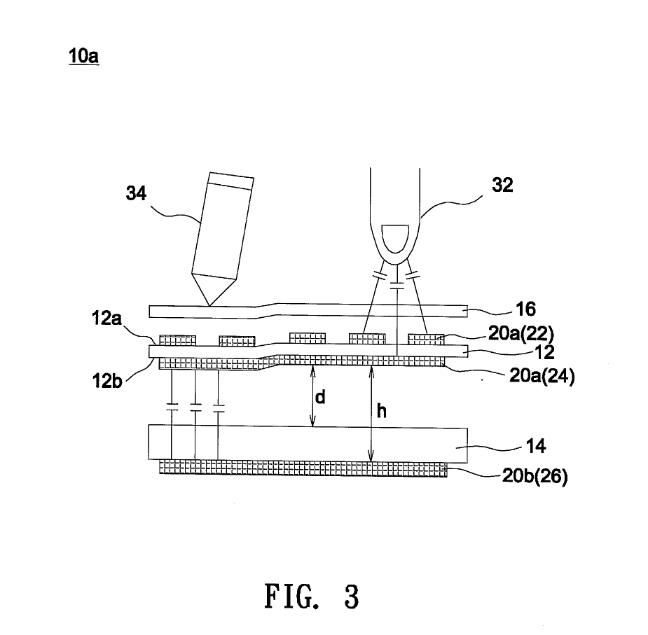

FIG. 3 shows a schematic diagram of a touch-sensitive device according to an embodiment of the invention. Referring to FIG. 3, a first touch-sensing electrode structure 20a of a touch-sensitive device 10a includes multiple first sensing series 22 formed on a first side 12a of a substrate 12 and multiple second sensing series 24 formed on a second side 12b of a substrate 12 opposite the first side 12a, and the second sensing series 24 cross the first sensing series 22. A substrate 14 is disposed adjacent to the second side 12b of the substrate 12 and spaced from the substrate 12 with an interval d. The second touch-sensing electrode structure 20b is formed on one side of the substrate 14 back to the first touch-sensing electrode structure 20a, and the second touch-sensing electrode structure 20b may be, for example, a transparent electrode layer 26. Further, a decorative film 16 is disposed adjacent to the first side 12a of the substrate 12. For example, when a conductor such as a finger 32 touches the touch-sensitive device 10a, additional charge storage capacity added by the finger 32 (finger capacitance) may alter the capacitance of the first touch-sensing electrode structure 20a such that at least one touch position of the finger 32 is detected in accordance with the capacitance variation of the first touch-sensing electrode structure 20a, and the capacitance variation of the first touch-sensing electrode structure 20a is sensed to detect at least one touch position of the finger 32. Further, when an insulator such as a stylus 34 touches the touch-sensitive device 10a, the substrate 12 deforms to decrease the interval h between the first touch-sensing electrode structure 20a and the second touch-sensing electrode structure 20b, and thus the coupling capacitance is enhanced to activate the touch-sensitive device 10a. Therefore, at least one touch position of the stylus 34 is detected by sensing a variation of the interval h between the first touch-sensing electrode structure 20a and the second touch-sensing electrode structure 20b. According to this embodiment, since the interval d between the substrate 12 and the substrate 14 is substantially equal to the interval h between the first touch-sensing electrode structure 20a and the second touch-sensing electrode structure 20b minus the thickness of the substrate 14, the overall thickness of the touch-sensitive device 10a is reduced (minus the thickness of the substrate 14) to realize a thin touch-sensitive device.

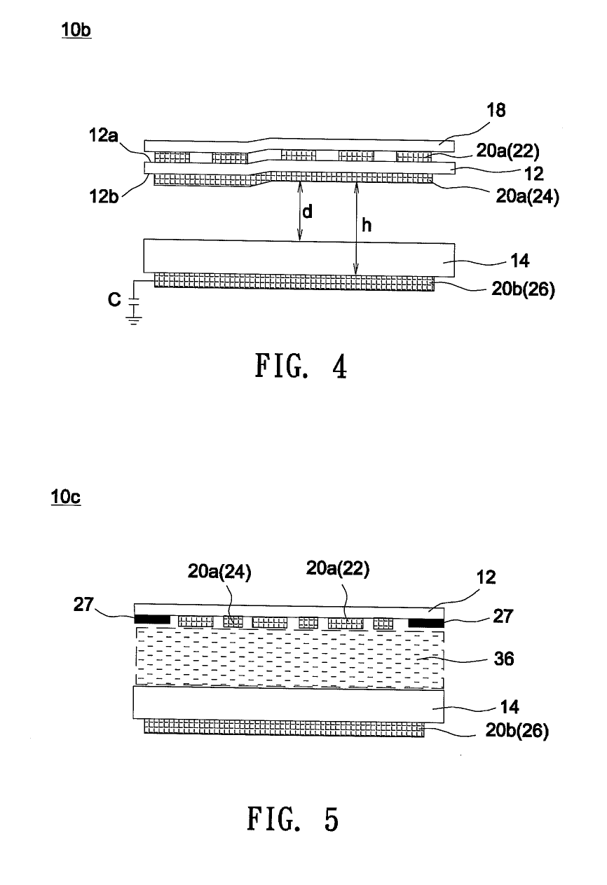

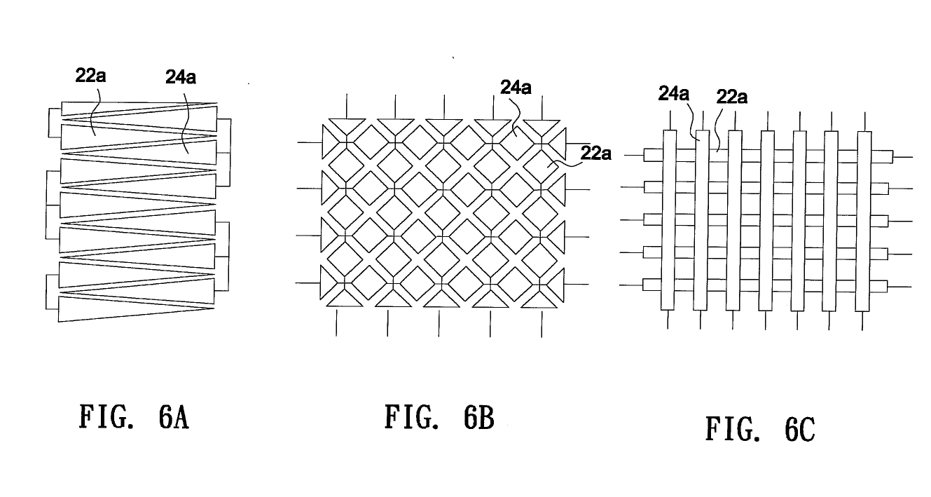

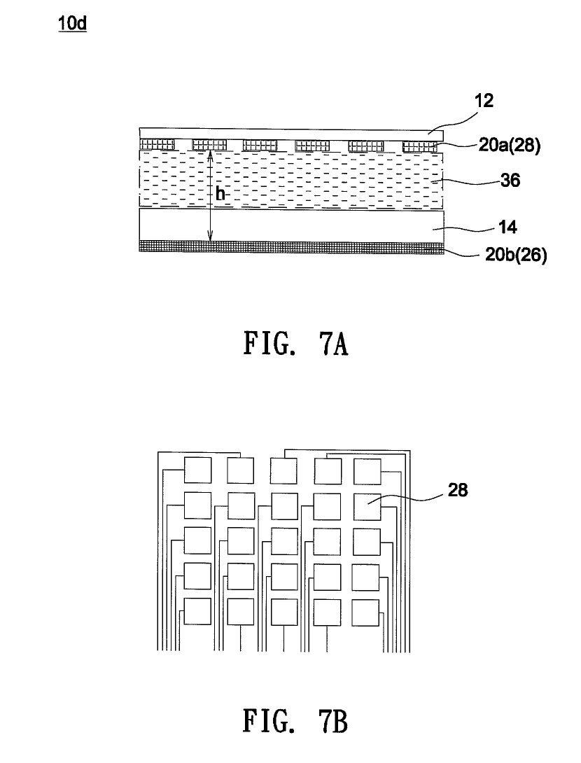

FIG. 4 shows a schematic diagram of a touch-sensitive device according to another embodiment of the invention. Referring to FIG. 4, the touch-sensitive device 10b further includes another substrate 18 disposed adjacent to the first side 12a of the first substrate 12, the first sensing series 22 are formed on one side of the substrate 18 facing the substrate 12, and the second sensing series 24 are formed on the second side 12b of the substrate. Referring to FIG. 5, in an alternate embodiment, the first touch-sensing electrode structure 20a of the touch-sensitive device 10c is in the form of a single-layer structure and formed on a single side of the substrate 12. Certainly, the first touch-sensing electrode structure 20a may be in the form of a multi-layer structure and formed on a single side of the substrate 12. A decorative layer 27 may be formed on a periphery of the substrate 12 to shield metal lines. The decorative layer 27 may include at least one of diamond like carbon, ceramic, colored ink, resin and photo resist. In the above embodiments, each of the sensing series 22 and 24 may include multiple transparent electrodes 22a and 24a, and the transparent electrodes 22a and 24a may be, but not limited to, in the shape of a triangle (FIG. 6A), a diamond (FIG. 6B) or a line segment (FIG. 6C). As shown in FIG. 7A and FIG. 7B, in an alternate embodiment, a first touch-sensing electrode structure 20a of a touch-sensitive device 10d includes multiple button electrodes 28 regularly arranged on one side of the substrate 12 facing the substrate 14, and a second touch-sensing electrode structure 20b (transparent electrode layer 26) is formed on one side of the substrate 14 back to the substrate 12. Therefore, finger capacitance is formed between a conductor such as a finger and button electrodes 28. Besides, when an insulator such as a stylus touches the touch-sensitive device 10d, the substrate 12 deforms to decrease an interval between the first touch-sensing electrode structure 20a and the second touch-sensing electrode structure 20b, and thus the coupling capacitance is enhanced to activate the touch-sensitive device 10d.

In all the above embodiments, each of the substrates 12, 14 and 18 may be a glass substrate or a plastic substrate. For example, in case the substrate 12 is a plastic substrate, the plastic substrate 12 is allowed to deform to a greater extent to provide higher coupling capacitance. Further, an air gap (shown in FIG. 3 and FIG. 4) may exist between substrate 14 and substrate 12, and the air gap may be filled with inactive gas such as air, nitrogen, helium and argon. In an alternate embodiment, a medium layer 36 (shown in FIG. 5) is interposed between the substrate 14 and the substrate 12. The material of the medium layer 36 includes, but not limited to, a solid-state filler or a liquid-state filler. The solid-state filler may be a resilient material such as made of solid-state adhesive or flexible plastic, or may be a combination of conductive spacers and dielectric spacers. The liquid-state filler may be made of liquid-state adhesive or liquid crystal.

In all the above embodiments, the second touch-sensing electrode structure 20b may be connected to a capacitor C before being grounded, as shown in FIG. 4. Since the capacitor C may provide certain amount of storage capacitance, touch positions can be still effectively detected even the substrate 12 deforms to a less extent to result in small coupling capacitance. Alternatively, the second touch-sensing electrode structure 20b may be directly grounded, connected to a voltage source, or floating.

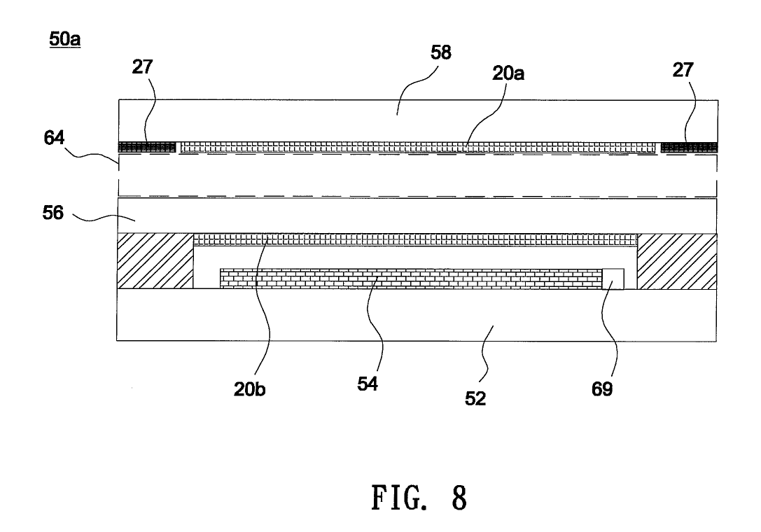

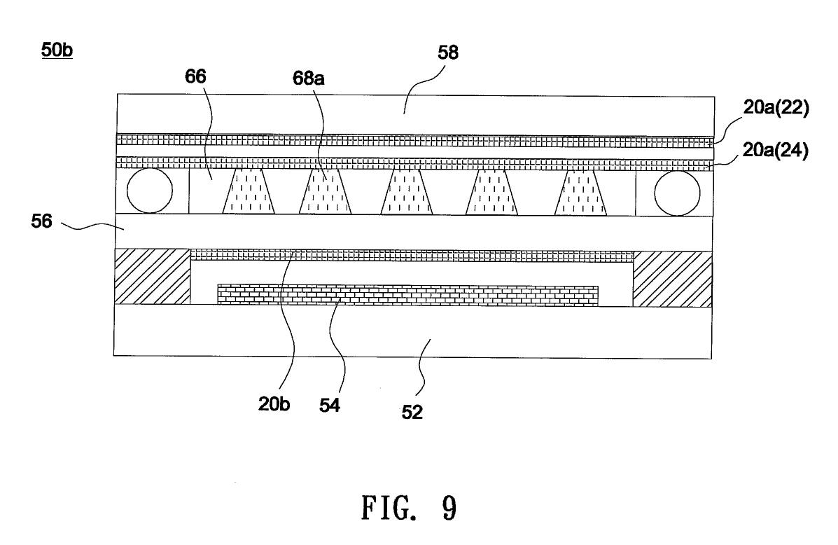

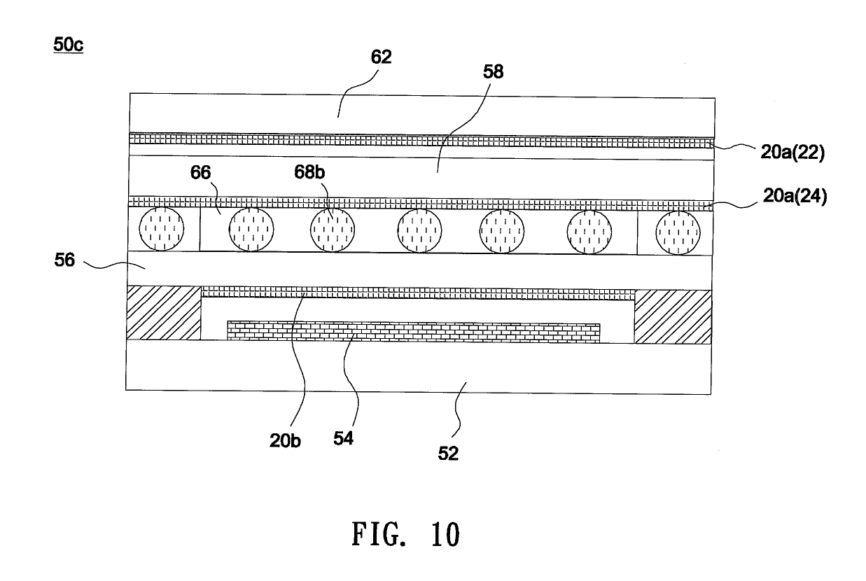

Herein, an arrangement of a touch-sensitive device in combination with a display device is described below in different embodiments. Referring to FIG. 8, in a touch-sensitive display device 50a, an organic light-emitting diode (OLED) 54 is formed on a first substrate 52, and a cover plate 56 is connected to the first substrate 52 to seal the OLED 54 between the first substrate 52 and the cover plate 56. A second substrate 58 is disposed on one side of the cover plate 56 back to the OLED 54, and the second substrate 58 is spaced from the cover plate 56 with an interval. A first touch-sensing electrode structure 20a is disposed on the second substrate 58, and a decorative layer 27 may be formed on a periphery of the second substrate 58 to shield metal lines. The decorative layer 27 may include at least one of diamond like carbon, ceramic, colored ink, resin and photo resist. At least one touch position of a conductor is detected by sensing the capacitance variation of the first touch-sensing electrode structure 20a. The second touch-sensing electrode structure 20b is formed on one side of the cover plate 56 back to the second substrate 58, and at least one touch position of an insulator is detected by sensing the variation of the interval between the first touch-sensing electrode structure 20a and the second touch-sensing electrode structure 20b. In this embodiment, the first touch-sensing electrode structure 20a may be in the form of a single-layer electrode structure and formed on a single side of the second substrate 58. Further, as shown in FIG. 9, a first touch-sensing electrode structure 20a of a touch-sensitive display device 50b may be in the form of a multi-layer electrode structure and formed on a single side of the second substrate 58. Alternatively, in a touch-sensitive display device 50c shown in FIG. 10, a third substrate 62 is additionally disposed on one side of the second substrate 58 back to the cover plate 56. The first touch-sensing electrode structure 20a may include multiple first sensing series 22 and multiple second sensing series 24, and the first sensing series 22 and the second sensing series 24 are respectively formed on the third substrate 62 and the second substrate 58. Besides, in the above embodiments, a gas-state filler 64 (shown in FIG. 8), such as an inactive gas like air, nitrogen, helium, argon, etc., is filled into a gap between the substrate 58 and the cover plate 56. Alternatively, a solid-state filler or a liquid-state filler may be filled into the gap, and photo spacers 68a (shown in FIG. 9) or dot spacers 68b (shown in FIG. 10) are dispersed in the solid-state filler or the liquid-state filler. Further, as shown in FIG. 8, multiple thin-film transistors 69 are disposed on the first substrate 52 to form a touch-sensitive display device 50a having an active-matrix type OLED.

According to the above embodiments of the touch-sensitive display devices 50a to 50c, a piece of glass substrate and an optical adhesive adhering the glass substrate are omitted, as compared with conventional designs. Accordingly, the loss of reflection light and the overall thickness of a touch-sensitive display device are reduced. Besides, the complexity is reduced and the production yields are improved in the integration process of a force sensor and an OLED device. Further, since a bottom substrate of a force sensor and a sealing cap of an OLED device in a conventional design are merged together to form the cover plate 56 in an embodiment of the invention, an air gap no longer exists therebetween to further improve the light-reflection efficiency.

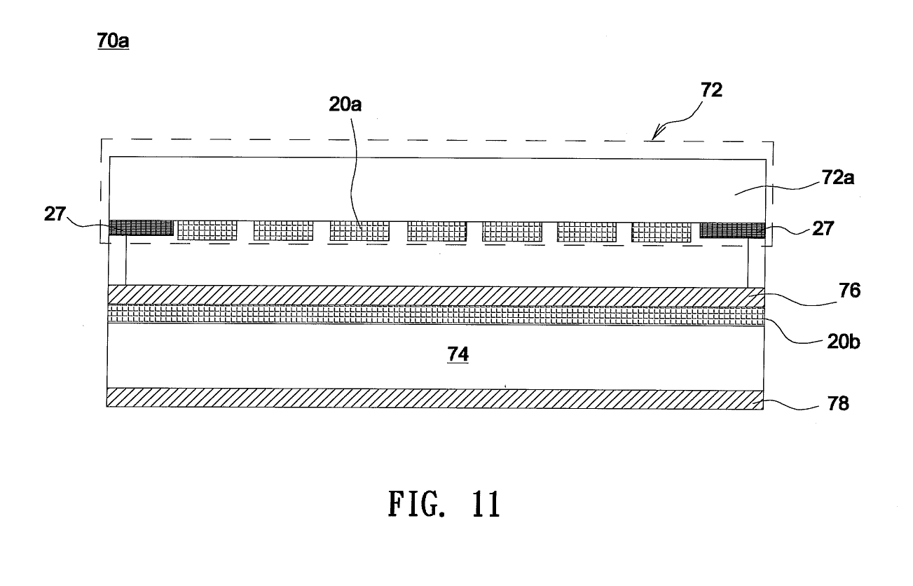

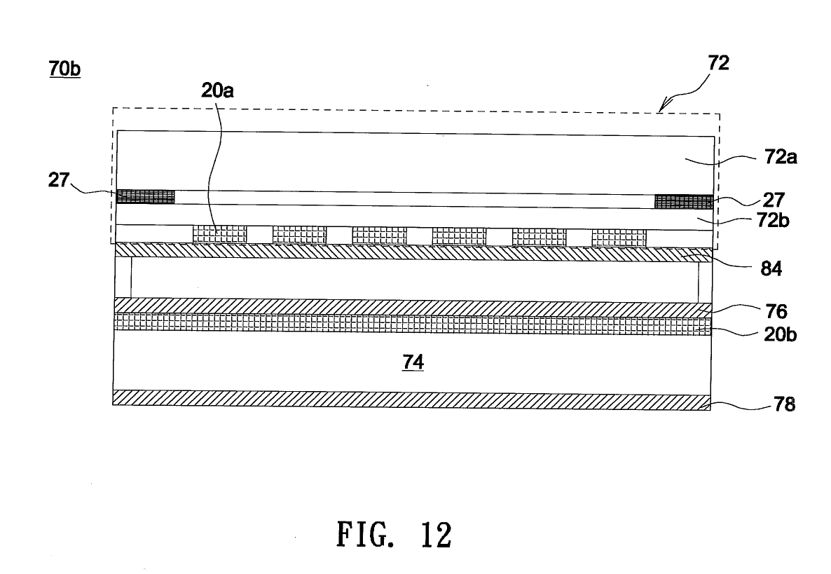

FIG. 11 shows a schematic diagram of a touch-sensitive display device according to another embodiment of the invention. Referring to FIG. 11, a touch-sensitive display device 70a includes a cover lens structure 72 and a liquid crystal display 74 combined with each other. The cover lens structure 72 includes a cover glass 72a and a first touch-sensing electrode structure 20a formed on the cover glass 72a. A decorative layer 27 may be formed on a periphery of the cover glass 72a to shield metal lines. The decorative layer 27 may include at least one of diamond like carbon, ceramic, colored ink, resin and photo resist. The liquid crystal display 74 is disposed on one side of the cover lens structure 72 and interposed between a first linear polarizer 76 and a second linear polarizer 78. The first linear polarizer 76 is disposed between the cover lens structure 72 and the liquid crystal display 74, and the second linear polarizer 78 is disposed on one side of the liquid crystal display 74 back to the cover lens structure 72. The second touch-sensing electrode structure 20b is formed on one side of the first linear polarizer 76 back to a first touch-sensing electrode structure 20a and facing the liquid crystal display 74, and the second touch-sensing electrode structure 20b is spaced from the first touch-sensing electrode structure 20a with an interval. Similarly, the capacitance variation of the first touch-sensing electrode structure 20a is sensed to detect at least one touch position of a conductor, and a variation of the interval between the first touch-sensing electrode structure 20a and the second touch-sensing electrode structure 20b due to deformation is sensed to detect at least one touch position of an insulator. In an alternate embodiment, in a touch-sensitive display device 70b shown in FIG. 12, a cover lens structure 72 may include a cover glass 72a, a substrate 72b, and a first touch-sensing electrode structure 20a. The cover glass 72a covers the substrate 72b, and a first touch-sensing electrode structure 20a is formed on one side of the substrate 72b back to the cover glass 72a. Further, a decorative layer 27 may be formed on a periphery of the cover glass 72a to shield metal lines. The decorative layer 27 may include at least one of diamond like carbon, ceramic, colored ink, resin and photo resist. Besides, a circular polarizer 84 may be disposed on one side of the first touch-sensing electrode structure 20a to serve the function of anti-reflection.

Note the materials of the aforesaid substrates and transparent electrodes are not limited. For example, each substrate may be a plastic substrate or a glass substrate, and the transparent electrode may include, but not limited to, an inorganic conductive material, a metallic conductive material, an oxide conductive material, a carbon nanotube conductive material, a nanotube fiber conductive material, a nanotube particle conductive material, a conductive polymer material, a metal polymer composite conductive material, a conductive polymer doped with a carbon compound, and a conductive polymer doped with an inorganic compound.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

What is claimed is:

1. A touch-sensitive device, comprising:
a first substrate;
a first touch-sensing electrode structure disposed on the first substrate, wherein at least one touch position of a conductor is detected by sensing the capacitance variation of the first touch-sensing electrode structure;
a second substrate disposed adjacent to the first substrate and spaced from the first substrate with an interval; and
a second touch-sensing electrode structure disposed on one side of the second substrate back to the first touch-sensing electrode structure,
wherein at least one touch position of an insulator is detected by sensing a variation of the interval between the first touch-sensing electrode structure and the second touch-sensing electrode structure.

2. The touch-sensitive device as claimed in claim 1, wherein the first substrate has a first side and a second side opposite the first side, the first touch-sensing electrode structure comprises a plurality of first sensing series and a second sensing series crossing the first sensing series, and the second touch-sensing electrode structure comprises a transparent electrode layer.

3. The touch-sensitive device as claimed in claim 2, wherein the first sensing series are disposed on the first side of the first substrate and the second sensing series are disposed on the second side of the first substrate.

4. The touch-sensitive device as claimed in claim 3, further comprising:
a decorative film disposed adjacent to the first side of the first substrate.

5. The touch-sensitive device as claimed in claim 2, further comprising:
a third substrate disposed adjacent to the first side of the first substrate, the first sensing series are formed on one side of the third substrate facing the first substrate, and the second sensing series are formed on the second side of the first substrate.

6. The touch-sensitive device as claimed in claim 5, wherein each of the first substrate and the third substrate is a glass substrate or a plastic substrate.

7. The touch-sensitive device as claimed in claim 2, wherein the first sensing series and the second sensing series are disposed on the second side of the first substrate.

8. The touch-sensitive device as claimed in claim 7, further comprising a decorative layer formed on a periphery of the first substrate.

9. The touch-sensitive device as claimed in claim 8, wherein the decorative layer comprises at least one of diamond like carbon, ceramic, colored ink, resin and photo resist.

10. The touch-sensitive device as claimed in claim 1, wherein the first touch-sensing electrode structure comprises a plurality of regularly arranged button electrodes.

11. The touch-sensitive device as claimed in claim 1, wherein the second touch-sensing electrode structure is floating, connected to a voltage source, directly grounded or connected to a capacitor before being grounded.

12. The touch-sensitive device as claimed in claim 1, wherein the interval is filled with at least one of a gas, a solid-state filler and a liquid-state filler.

13. A touch-sensitive display device, comprising:
a first substrate ;
an OLED formed on the first substrate;
a cover plate connected to the first substrate to seal the OLED between the first substrate and the cover plate;
a second substrate disposed on one side of the cover plate back to the OLED and spaced from the cover plate with an interval;
a first touch-sensing electrode structure disposed on the second substrate, wherein at least one touch position of a conductor is detected by sensing the capacitance variation of the first touch-sensing electrode structure; and
a second touch-sensing electrode structure formed on one side of the cover plate back to the second substrate, wherein at least one touch position of an insulator is detected by sensing the variation of the interval between the first touch-sensing electrode structure and the second touch-sensing electrode structure.

14. The touch-sensitive display device as claimed in claim 13, wherein the first touch-sensing electrode structure comprises a plurality of first sensing series and a plurality of second sensing series crossing the first sensing series, and the first sensing series and the second sensing series are formed on a single side of the second substrate.

15. The touch-sensitive display device as claimed in claim 13, further comprising:
a third substrate disposed adjacent to one side of the second substrate back to the cover plate, wherein the first touch-sensing electrode structure are formed on the second substrate and the third substrate.

16. The touch-sensitive display device as claimed in claim 13, wherein the second touch-sensing electrode structure is floating, connected to a voltage source, directly grounded or connected to a capacitor before being grounded.

17. The touch-sensitive display device as claimed in claim 13, wherein the interval is filled with at least one of a gas, a solid-state filler and a liquid-state filler.

18. The touch-sensitive display device as claimed in claim 13, further comprising photo spacers or dot spacers dispersed in the interval between the second substrate and the cover plate.

19. The touch-sensitive display device as claimed in claim 13, further comprising a decorative layer formed on a periphery of the second substrate.

20. The touch-sensitive display device as claimed in claim 19, wherein the decorative layer comprises at least one of diamond like carbon, ceramic, colored ink, resin and photo resist.

21. A touch-sensitive display device, comprising:
a cover lens structure having a first touch-sensing electrode structure, wherein at least one touch position of a conductor is detected by sensing the capacitance variation of the first touch-sensing electrode structure;
a liquid crystal display disposed on one side of the cover lens structure;
a first linear polarizer disposed between the cover lens structure and the liquid crystal display;
a second linear polarizer disposed on one side of the liquid crystal display back to the cover lens structure; and
a second touch-sensing electrode structure disposed on one side of the first linear polarizer back to the first touch-sensing electrode structure, and the second touch-sensing electrode structure being spaced from the first touch-sensing electrode structure with an interval, wherein at least one touch position of an insulator is detected by sensing the variation of the interval between the first touch-sensing electrode structure and the second touch-sensing electrode structure.

22. The touch-sensitive display device as claimed in claim 21, wherein the cover lens structure has a cover glass and a first touch-sensing electrode structure formed on the cover glass, and the second touch-sensing electrode structure is formed on one side of the first linear polarizer back to the first touch-sensing electrode structure.

23. The touch-sensitive display device as claimed in claim 21, wherein the cover lens structure comprises a first substrate, a cover glass covering the first substrate and a first touch-sensing electrode structure, wherein the first touch-sensing electrode structure is formed on one side of the first substrate back to the cover glass.

24. The touch-sensitive display device as claimed in claim 21, further comprising:
a circular polarizer disposed on one side of the first touch-sensing electrode structure.

25. The touch-sensitive display device as claimed in claim 21, further comprising a decorative layer formed on a periphery of the cover lens structure.

26. The touch-sensitive display device as claimed in claim 25, wherein the decorative layer comprises at least one of diamond like carbon, ceramic, colored ink, resin and photo resist.
